(19) United States
(12) Patent Application Publication
(10) Pub. No.: US 2026/0121413 A1
(43) Pub. Date: Apr. 30, 2026

(54) DYNAMIC COORDINATION APPROACH INTEGRATING FLEXIBLE DIRECT CURRENT SAME-FREQUENCY CONTROL WITH CONSTANT DIRECT CURRENT UNILATERAL FLC COORDINATED CONTROL AND VOLTAGE SUPPORT

(71) Applicant: Kunming University of Science and Technology, Kunming (CN)

(72) Inventors: Hongchun SHU, Kunming (CN); Zongxue SHAO, Kunming (CN); Yongzan CUI, Kunming (CN); Yutao TANG, Kunming (CN); Guangxue WANG, Kunming (CN); Yinan HU, Kunming (CN); Shunguang LEI, Kunming (CN)

(73) Assignee: Kunming University of Science and Technology, Kunming (CN)

(21) Appl. No.: 19/021,331

(22) Filed: Jan. 15, 2025

(30) Foreign Application Priority Data
Oct. 17, 2024 (CN) 202411451572.1

(51) Int. Cl. H02J 3/16; G05B 11/42; H02J 3/24; H02J 3/36; H02J 4/00

(52) U.S. Cl. CPC H02J 3/16; G05B 11/42; H02J 3/00142; H02J 3/36; H02J 4/00

(57) ABSTRACT

A dynamic coordination method for flexible direct current (DC) same-frequency control in conjunction with conventional DC single-sided frequency limit control (FLC) and voltage support. This method obtains the flexible DC power adjustment based on the sending-end grid frequency, receiving-end grid frequency, and the system frequency reference value. Subsequently, when the flexible DC power adjustment exceeds a preset limiting range and the system frequency deviation surpasses a preset frequency control dead-band, it outputs the conventional DC power adjustment based on the sending-end grid frequency and the system frequency reference value. Furthermore, based on the conventional DC power adjustment and the original reactive power reference value of the Voltage Source Converter (VSC), reactive power support is provided. This achieves the objectives of fully leveraging the rapid controllability of DC transmission systems, employing flexible DC same-frequency control for flexible DC and single-sided FLC for conventional DC, and swiftly balancing system active power deficiencies.

### CROSS-REFERENCE TO THE RELATED APPLICATIONS

This application is based upon and claims priority to Chinese Patent Application No. 202411451572.1, filed on Oct. 17, 2024, the entire contents of which are incorporated herein by reference.

### TECHNICAL FIELD

This application relates to the field of power system stability and control technology, specifically to a dynamic coordination method that integrates flexible direct current (FDC) with constant frequency control, unilateral flexible line converter (FLC) coordinated control, and voltage support.

### BACKGROUND

A large alternating current (AC)-DC hybrid synchronous power grid system refers to the combination of traditional AC transmission systems and high-voltage DC transmission systems to form a unified, efficient, and reliable power transmission network. This system enables long-distance, high-capacity power transmission while offering good regulation performance and economic efficiency.

However, traditional large AC-DC hybrid synchronous power grid systems are prone to issues such as excessive short-circuit currents, fault propagation, and low-frequency oscillations during operation. Therefore, in such systems, DC asynchronous interconnection is often adopted to limit short-circuit current levels, eliminate the possibility of low-frequency oscillations from a structural perspective, and block the transmission of AC faults within the network structure.

Nevertheless, after the large AC-DC hybrid synchronous power grid system is interconnected through DC asynchronous links, the rotational inertia and frequency regulation capacity of the original synchronous grid are divided. As a result, the rotational inertia and frequency regulation capacity of each subsystem are significantly reduced compared to the entire system, making frequency stability issues in the asynchronous regional grids a major concern for their stability.

The above discussion serves solely to aid in understanding the technical framework of the present invention and does not imply recognition of the aforementioned content as prior art.

### SUMMARY

In light of the above content, it is necessary to provide a dynamic coordination method that integrates flexible direct current same-frequency control with constant direct current unilateral FLC coordinated control and voltage support, capable of solving the technical problem of insufficient frequency stability in asynchronous regional power grids.

On the one hand, the present application proposes a dynamic coordination method that integrates flexible direct current (FDC) same-frequency control with constant direct current (CDC) unilateral FLC coordinated control and voltage support. The method includes:
Based on the frequency of the sending-end power grid, the frequency of the receiving-end power grid, and the system frequency reference value, obtain the adjustable power amount for the flexible direct current (FDC) system;
When the adjustable power amount for the FDC system exceeds a preset limiting range, and the system frequency deviation exceeds a preset frequency control dead band, output an adjustable power amount for the constant direct current (CDC) system based on the frequency of the sending-end power grid and the system frequency reference value;
And provide reactive power support based on the adjustable power amount for the CDC system and the original reactive power reference value for the Voltage Source Converter (VSC).

In some embodiments of the present application, the step of obtaining the adjustable power amount for the FDC system based on the frequency of the sending-end power grid, the frequency of the receiving-end power grid, and the system frequency reference value includes:
Determining the difference between the frequency of the sending-end power grid and the system frequency reference value, as well as determining the difference between the frequency of the receiving-end power grid and the system frequency reference value;
Performing filtering, direct current component elimination, Proportional-Integral (PI) control, and limiting operations on the difference between the frequency of the sending-end power grid and the system frequency reference value, as well as on the difference between the frequency of the receiving-end power grid and the system frequency reference value, to obtain the adjustable power amount for the flexible direct current (FDC) system.

In some embodiments of the present application, after the step of obtaining the adjustable power amount for the flexible direct current (FDC) system based on the frequency of the sending-end power grid, the frequency of the receiving-end power grid, and the system frequency reference value, the method further includes:
Adding the adjustable power amount for the FDC system to the original power reference value of the flexible direct current (FDC) system to obtain the active power instruction for the Voltage Source Converter (VSC);
Regulating the actual operating power of the flexible direct current (FDC) system in accordance with the active power command of the Voltage Source Converter (VSC) and the range of the FDC power adjustment.

In some embodiments of the present application, prior to the step of adjusting the actual operating power of the flexible direct current (FDC) system based on the active power instruction of the Voltage Source Converter (VSC) and the range of the FDC power adjustment, the method further includes:
Determining the upper limit of the range for the adjustable power amount of the FDC system based on the rated power of the FDC system, the actual operating power of the FDC system, and the overload capacity coefficient of the FDC system;
Determining the lower limit of the range for the adjustable power amount of the FDC system based on the rated power of the FDC system, the actual operating power of the FDC system, and the minimum operating level coefficient of the FDC system power;
Based on the upper limit and the (corrected to) lower limit of the range for the adjustable power amount of the FDC system, determining the overall range for the adjustable power amount of the FDC system.

In some embodiments of the present application, after the step of outputting a constant direct power adjustment amount based on the frequency of the sending-end power grid and the system frequency reference value when the adjustable power amount of the FDC system exceeds a preset limiting range and the system frequency deviation exceeds a preset frequency control dead band, the method further includes:
Performing logical judgment, per-unit processing, and PI (Proportional-Integral) control on the constant direct power adjustment amount to obtain the corresponding trigger angle adjustment amount for the constant direct power adjustment.

Adjusting the actual operating power of the conventional direct current (CDC) system based on the trigger angle adjustment amount and the range of the constant direct power adjustment amount.

In some embodiments of the present application, the step of providing reactive power support based on the constant direct power adjustment amount and the original reactive power reference value of the Voltage Source Converter (VSC) includes:
Performing a power factor calculation on the constant direct power adjustment amount to obtain an additional reactive power adjustment amount for the VSC;
Adding the additional reactive power adjustment amount for the VSC to the original reactive power instruction of the VSC to obtain an updated reactive power instruction for the VSC;
Based on the updated reactive power command for the VSC, providing reactive power support, which encompasses regulating the reactive power generated by the flexible direct current (FDC) system.

In some embodiments of the present application, the step of performing a power factor calculation on the constant direct power adjustment amount to obtain an additional reactive power adjustment amount for the Voltage Source Converter (VSC) includes:
Determining the tangent value of the power factor measured at the conventional direct current (CDC) valve connected to the flexible direct current (FDC) system.
Performing a multiplication operation on the tangent value and the constant direct power adjustment amount to obtain the additional reactive power adjustment amount for the Voltage Source Converter (VSC).

On the other hand, the present application also proposes an AC-DC hybrid synchronous grid system, which includes:
A flexible direct current (FDC) same-frequency control unit, which is used to obtain an adjustable FDC power amount based on the frequency of the sending-end power grid, the frequency of the receiving-end power grid, and the system frequency reference value.

A constant direct current (CDC) unilateral Frequency Limiting Controller (FLC) control unit, which is used to output a constant direct power adjustment amount based on the frequency of the sending-end power grid and the system frequency reference value when the adjustable flexible direct current (FDC) power amount exceeds a preset limiting range and the system frequency deviation exceeds a preset frequency control dead band.

A VSC dynamic adaptive reactive power support control unit, which is used to provide reactive power support based on the constant direct power adjustment amount and the original reactive power reference value of the Voltage Source Converter (VSC).

On the other hand, the present application also proposes an AC-DC hybrid synchronous equipment, which includes: a storage device storing computer-readable instructions; and a processor executing the computer-readable instructions stored in the storage device to implement a dynamic coordination method for flexible direct current (FDC) same-frequency control, constant direct current (CDC) unilateral Frequency Limiting Controller (FLC) coordinated control, and voltage support.

On the other hand, the present application also proposes a storage medium, which stores computer-readable instructions. When executed by a processor in an AC-DC hybrid synchronous equipment, the computer-readable instructions implement a dynamic coordination method for flexible direct current (FDC) same-frequency control, constant direct current (CDC) unilateral Frequency Limiting Controller (FLC) coordinated control, and voltage support.

From the above technical solution, it can be seen that the present application obtains an adjustable flexible direct current (FDC) power amount based on the frequency of the sending-end power grid, the frequency of the receiving-end power grid, and the system frequency reference value. Then, when the adjustable FDC power amount exceeds a preset limiting range and the system frequency deviation exceeds a preset frequency control dead band, a constant direct current (CDC) power adjustment amount is output based on the frequency of the sending-end power grid and the system frequency reference value. Furthermore, reactive power support is provided based on the CDC power adjustment amount and the original reactive power reference value of the Voltage Source Converter (VSC). This implementation utilizes FDC same-frequency control to ensure consistency and synchronization between the frequencies of the sending-end power grid and the receiving-end power grid within the range of adjustable FDC power, enabling real-time and automatic sharing of frequency regulation resources between the sending and receiving ends of the power grid. It also leverages CDC unilateral Frequency Limiting Controller (FLC) to improve the frequency stability of the sending-end power grid. Additionally, it employs VSC dynamic adaptive reactive power support control to provide rapid reactive power support to the conventional direct current system, avoiding frequent operations of the CDC converter transformer and filters during CDC unilateral FLC action, and thereby extending the lifespan of the direct current equipment.

### BRIEF DESCRIPTION OF THE DRAWINGS

The accompanying drawings incorporated herein and forming a part of this specification illustrate embodiments consistent with the present application and, together with the specification, serve to explain the principles of the present application.

To more clearly illustrate the technical solutions in the embodiments of the present application or in the prior art, a brief introduction to the drawings required for describing the embodiments or the prior art will be provided below: It is apparent to those skilled in the art that, without departing from the inventive concept, other drawings can be obtained based on these drawings.

FIG. 1 is a flowchart of the dynamic coordination method for flexible direct current (FDC) same-frequency control, constant direct current (CDC) unilateral Frequency Limiting Controller (FLC) coordinated control, and voltage support provided in an embodiment of the present application.

FIG. 2 is a functional block diagram of an AC-DC hybrid synchronous power grid system provided in an embodiment of the present application.

FIG. 3 is a schematic diagram of the device structure of the hardware operating environment involved in the dynamic coordination method for FDC same-frequency control, CDC unilateral FLC coordinated control, and voltage support in an embodiment of the present application.

### DETAILED DESCRIPTION OF THE EMBODIMENTS

It should be understood that the specific embodiments described herein are merely to explain the technical solutions of the present application and are not intended to limit the present application.

It should be noted that in the present application, “at least one” refers to one or more, and “multiple” refers to two or more. The term “and/or” describes the relationship between associated objects, indicating that three relationships may exist: A alone, both A and B, and B alone, where A and B can be singular or plural. The terms “first,” “second,” “third,” “fourth,” etc. (if any) in the specification, claims, and drawings of the present application are used to distinguish similar objects and are not intended to describe a specific order or sequence.

In the embodiments of the present application, the terms “exemplary” or “for example” are used to indicate examples, illustrations, or explanations. Any embodiment or design described in the embodiments of the present application as “exemplary” or “for example” should not be interpreted as being more preferred or advantageous than other embodiments or designs. Rather, the use of the terms “exemplary” or “for example” is intended to present related concepts in a specific manner. The embodiments and features described below can be combined with each other without conflict.

For ease of understanding, the technical terms involved in the embodiments of the present application are introduced below.

1. Flexible Direct Current (FDC) Transmission Technology: A transmission technology based on Voltage Source Converter (VSC) that offers high controllability and flexibility: The basic principle involves utilizing VSC, self-commutated devices, and Pulse Width Modulation (PWM) technology to achieve highly controllable power transmission. By adjusting the output voltage magnitude and phase angle of the VSC, the transmission of active and reactive power can be independently controlled.

VSC is the core component of the FDC transmission system, typically using Insulated Gate Bipolar Transistor (IGBT) or Gate-Turn-Off Thyristor (GTO) as the commutable devices. These devices can switch rapidly, enabling high-frequency modulation and precise control of current and voltage.

2. FDC Same-Frequency Control: A technology that utilizes FDC transmission to achieve frequency synchronization between different power grid zones. This technology allows for the coordination of different power grid areas through power electronic devices regulating current and voltage without direct physical connection.

3. FLC: Stands for Frequency Limiter Controller. It is a device used to control and regulate the frequency of a power system to ensure stability under different operating conditions. By adjusting the transmission of active and reactive power, FLC can effectively prevent frequency fluctuations and improve the reliability of the power system.

4. CDC Unilateral FLC Control: In FDC transmission systems, a control strategy where FLC is configured only at the sending end. By placing FLC at the sending end, CDC unilateral FLC control can effectively manage the transmission of active and reactive power, maintaining system frequency stability:

5. VSC Dynamic Adaptive Reactive Power Support Control: This involves real-time monitoring of the frequency changes in the AC system and automatically adjusting the output of reactive current to support and stabilize AC voltage. The core idea of this control method is to utilize the high controllability of VSC to dynamically adjust reactive power based on system needs, thereby maintaining stable grid operation.

6. Dead Zone: In the field of power system stability and control technology, a dead zone typically refers to a fault or protection blind spot within a specific area. It represents faults occurring in regions that cannot be covered by certain equipment or protective devices. These areas are usually formed due to limitations in the physical layout of equipment or protection logic.

In the context of typical protection dead zones in 220 kV substations, due to inherent defects in the working principles of relay protection devices, when a fault occurs within a specific small range of the protected component, it may not be promptly isolated, resulting in a dead zone fault. Although the probability of such faults occurring is relatively low, as the power grid becomes increasingly complex, their impact on the stable operation of the system is gradually increasing.

7. PI Control: Also known as Proportional-Integral Control, PI control is based on two main components: Proportional (P) and Integral (I). The proportional component responds instantaneously to system deviations, initiating adjustments to reduce errors as soon as they occur. The integral component, on the other hand, works to eliminate long-term errors, enhancing the system's accuracy.

In power systems, PI control continuously adjusts control variables such as voltage and current to bring the actual system output close to or equal to the desired value. Within the grid, PI control is utilized to regulate transformer tap positions and the output of reactive power compensation devices, thereby maintaining voltage levels and balancing reactive power.

To clarify the objectives, technical solutions, and advantages of this application, a detailed description is provided below; accompanied by figures and specific implementation examples.

In large AC-DC hybrid synchronous power grid systems, issues such as excessive short-circuit currents, fault propagation, and low-frequency oscillations frequently arise. To limit short-circuit current levels, eliminate the possibility of low-frequency oscillations from the network structure, and block the transmission of AC faults within the network structure, DC asynchronous interconnection is a preferred solution.

After large synchronous power grids are interconnected asynchronously through DC links, the rotational inertia and frequency regulation capacity of the original synchronous grid are divided. The rotational inertia and frequency regulation capacity of each subsystem are much smaller than those of the entire system, making frequency stability the primary stability issue in asynchronous regional grids.

To address the frequency stability issue in asynchronous regional grids, the embodiment of this application first calculates the flexible DC power adjustment based on the sending-end grid frequency, receiving-end grid frequency, and system frequency reference value. Then, when the flexible DC power adjustment exceeds a preset limiting range and the system frequency deviation exceeds a preset frequency control dead zone, a constant DC power adjustment is output based on the sending-end grid frequency and the system frequency reference value. Furthermore, based on this constant DC power adjustment and the original reactive power reference value of the Voltage Source Converter (VSC), reactive power support is provided. This approach fully leverages the rapid controllability of DC transmission systems, with flexible DC employing synchronous frequency control and conventional DC utilizing unilateral Frequency Limiting Controller (FLC) control, to quickly balance the system's active power deficit, participate in primary frequency regulation, and effectively enhance system frequency stability:

It should be noted that the executing entity of this embodiment can be a computing service device with data processing, network communication, and program execution capabilities, such as a tablet, personal computer, smartphone, or other electronic devices capable of fulfilling these functions, including AC-DC hybrid synchronous equipment. Here, the following description of this embodiment and subsequent embodiments will be illustrated using AC-DC hybrid synchronous equipment as an example.

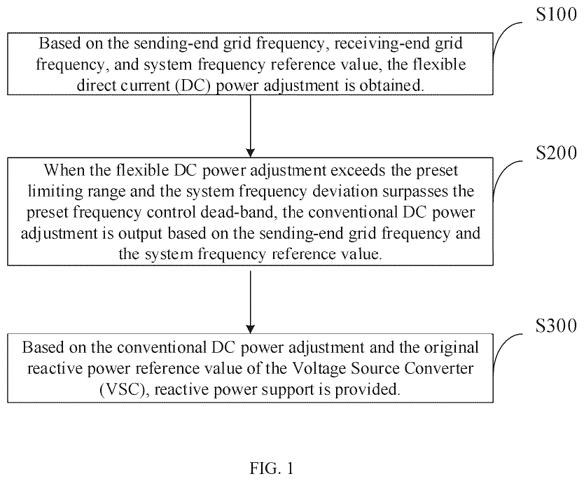

Refer to FIG. 1, which illustrates the flow diagram of the first embodiment of the dynamic coordination method for flexible DC synchronous frequency control, conventional DC unilateral FLC control, and voltage support in this application.

In this embodiment, the dynamic coordination method for flexible DC synchronous frequency control, conventional DC unilateral FLC control, and voltage support includes steps S100 to S300:
Step S100: Obtain the flexible DC power adjustment based on the sending-end grid frequency; receiving-end grid frequency, and system frequency reference value.

It should be noted that the sending-end grid frequency refers to the frequency state of the sending-end grid when electrical energy is transmitted from the generation side (sending end) to the consumption side (receiving end) through high-voltage DC transmission technology in the power system. The receiving-end grid frequency refers to the grid frequency state of the side (receiving end) that receives electrical energy through high-voltage DC transmission technology in the power system.

The system frequency reference value is the standard frequency value set for the power system under normal operating conditions. This reference value is the target of power system frequency control and is also an important indicator for measuring power system frequency stability: In different countries and regions, the system frequency reference value may vary, but it is usually around 50 Hz or 60 Hz. The setting of the system frequency reference value needs to comprehensively consider various factors such as the load characteristics, generating capacity, and transmission distance of the power system.

In this embodiment, when obtaining the flexible DC power adjustment, the difference between the sending-end grid frequency and the system frequency reference value, as well as the difference between the receiving-end grid frequency and the system frequency reference value, can be determined first. Then, by performing control processes such as filtering, DC blocking, PI control, and limiting on the differences, the flexible DC power adjustment can be obtained.

Furthermore, after obtaining the flexible DC power adjustment, it is added to the original power reference value of the Voltage Source Converter (VSC) to obtain the VSC active power command. Then, based on the VSC active power command and the range of the flexible DC power adjustment, the actual operating power of the flexible DC is adjusted.

In some embodiments of this application, the method for determining the range of the flexible DC power adjustment includes:
Step S110: Determine the upper limit of the range of the flexible DC power adjustment based on the rated power of the flexible DC, the actual operating power of the flexible DC, and the overload capability coefficient of the flexible DC.
Step S120: Determine the lower limit of the range of the flexible DC power adjustment based on the rated power of the flexible DC, the actual operating power of the flexible DC, and the minimum operating level coefficient of the flexible DC power.
Step S130: Determine the range of the flexible DC power adjustment based on the upper limit and the lower limit of the range of the flexible DC power adjustment.

In this embodiment, the formula for calculating the upper limit ΔPmax1 of the range of the flexible DC power adjustment can be expressed as ΔPₘₐₓ₁=k₁P_{N1}−P₁. In the formula, P_{N1} represents the rated power of the flexible DC, P₁ represents the actual operating power of the flexible DC, and k₁ represents the overload capability coefficient of the flexible DC. Currently; the maximum value of k₁ is generally taken as 1.05, but as the capacity of the switching devices in the flexible DC converter valves increases, the maximum value of k₁ will continue to increase.

The formula for calculating the lower limit ΔPₘᵢₙ₁ of the range of the flexible DC power adjustment can be expressed as ΔPₘᵢₙ₁=P₁−m₁P_{N1}. In the formula, m₁ represents the minimum operating level coefficient of the flexible DC power. When the flexible DC converter valve adopts a hybrid structure of full-bridge submodules and half-bridge submodules, m₁ can be set to zero.

When the value of m₁ is less than zero, it indicates a power flow reversal in the flexible DC system, and the specific value of m₁ is determined by the actual operating conditions.

Step S200: When the flexible DC power adjustment exceeds the preset limiting range and the system frequency deviation exceeds the preset frequency control dead-band, output a constant DC power adjustment based on the sending-end grid frequency and the system frequency reference value.

In this embodiment, the flexible DC power adjustment serves as the criterion for outputting the constant DC power adjustment and initiating subsequent reactive power support. When the flexible DC power adjustment exceeds the limit range and the system frequency deviation exceeds the preset frequency control dead-band, the steps of outputting the constant DC power adjustment and providing reactive power support are executed. It should be noted that the preset frequency control dead-band refers to the frequency control dead-band of the constant DC single-sided Frequency Load Control (FLC) unit. Preferably, the range of the preset frequency control dead-band is from −0.14 Hz to −0.1 Hz and from 0.1 Hz to 0.14 Hz.

Furthermore, after outputting the constant DC power adjustment, perform logical judgment, per-unit processing, and PI control on the constant DC power adjustment to obtain the corresponding trigger angle adjustment. Then, adjust the actual operating power of the conventional DC based on the trigger angle adjustment and the range of the constant DC power adjustment.

Optionally, when obtaining the constant DC power adjustment, first calculate the difference between the sending-end grid frequency and the system frequency reference value, and then pass this difference through control stages such as dead-band, PI control, and limiting to obtain the constant DC power adjustment.

In some embodiments of this application, the range of the constant DC power adjustment can be determined by determining the upper and lower limits of the constant DC power adjustment range.

Optionally, the formula for calculating the upper limit ΔPₘₐₓ₂ of the range of the constant DC power adjustment can be expressed as ΔPₘₐₓ₂=k₂P_{N2}−P₂. In the formula, P_{N2} represents the rated power of the conventional DC, P₂ represents the actual operating power of the conventional DC, and k₂ represents the overload capability coefficient of the conventional DC. For long-term overload conditions, the maximum value of k₂ is generally taken as 1.1, and for short-term overload conditions, the maximum value of k₂ is generally taken as 1.2.

The formula for calculating the lower limit ΔPₘᵢₙ₂ of the range of the constant DC power adjustment can be expressed as ΔPmin2=P₂−m₂P_{N2}. In the formula, m₂ represents the minimum operating level coefficient of the conventional DC power, and the value of m₂ is 0.5.

Step S300: Provide reactive power support based on the constant DC power adjustment and the original reactive power reference value of the Voltage Source Converter (VSC).

In this embodiment, before providing reactive power support, a power factor calculation is performed on the constant DC power adjustment to obtain the additional reactive power adjustment for the VSC. Then, the additional reactive power adjustment for the VSC and the original reactive power command for the VSC are superimposed to obtain an updated reactive power command for the VSC. Subsequently; reactive power support is provided based on the updated reactive power command for the VSC. This reactive power support includes adjusting the reactive power generated by the flexible DC, thereby enabling the flexible DC to provide AC voltage support to the conventional DC.

In some embodiments of this application, the steps for performing the power factor calculation on the constant DC power adjustment to obtain the additional reactive power adjustment for the VSC include:
Step S310: Determine the tangent of the power factor of the conventional DC valve measurement connected to the flexible DC.
Step S320: Perform a multiplication operation on the tangent value and the constant DC power adjustment to obtain the additional reactive power adjustment for the VSC.

Specifically; the formula for calculating the additional reactive power adjustment for the VSC can be expressed as ΔQ=ΔP_{d2} tan φ. In this formula, φ represents the power factor of the conventional DC valve side connected to the flexible DC.

As an optional implementation, for the active power command of the VSC obtained by superimposing the flexible DC power adjustment and the original power reference value of the flexible DC, and the updated reactive power command of the VSC obtained by superimposing the additional reactive power adjustment for the VSC and the original reactive power command of the VSC, these values are processed through a dynamic limiting link including PI control to generate the active power command i_{dref} and the reactive power command i_{qref} required for the inner loop control of the VSC.

As another optional implementation, for the active power command i_{dref} and the reactive power command i_{qref} required for the inner loop control of the Voltage Source Converter (VSC), the formula for their dynamic limiting can be expressed as

$$\sqrt{{i}_{dref}^{2} + {i}_{qref}^{2}} \leq 1.2 .$$

In the technical solution provided by this embodiment, the flexible DC power adjustment is obtained based on the sending-end grid frequency, the receiving-end grid frequency; and the system frequency reference value. Then, when the flexible DC power adjustment exceeds the preset limiting range and the system frequency deviation exceeds the preset frequency control dead-band, a conventional DC power adjustment is output based on the sending-end grid frequency and the system frequency reference value. Furthermore, based on the conventional DC power adjustment and the original reactive power reference value of the VSC, reactive power support is provided. This achieves the use of flexible DC same-frequency control to ensure consistency and synchronization between the sending-end grid and the receiving-end grid frequency within the range of flexible DC power adjustment, enabling real-time and automatic sharing of frequency regulation resources between the sending and receiving ends of the grid. It also achieves the improvement of frequency stability of the sending-end grid using conventional DC unilateral frequency load control (FLC). Additionally, it realizes the use of dynamic adaptive reactive power support control of the VSC to provide rapid reactive power support to the conventional DC, avoiding frequent operation of the conventional DC converter transformers and filters during the action of the conventional DC unilateral FLC, thus improving the service life of DC equipment.

It should be noted that the above examples are only for the purpose of understanding this application and do not constitute a limitation on the dynamic coordination method of flexible DC same-frequency control and conventional DC unilateral FLC, as well as voltage support, described in this application. Any simple variations in more forms based on this technical concept are within the scope of protection of this application.

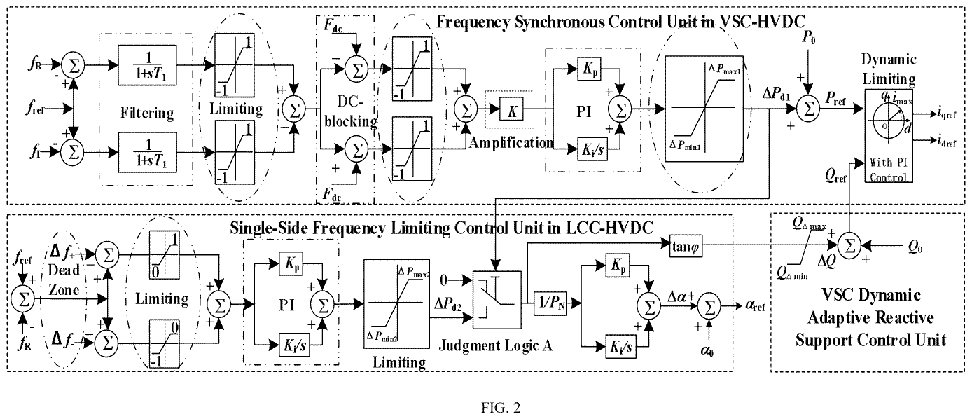

As shown in FIG. 2, it is a functional block diagram of the AC-DC hybrid synchronous grid system 100 provided in an embodiment of this application. The AC-DC hybrid synchronous grid system 100 includes a flexible DC same-frequency control unit 110, a conventional DC unilateral FLC control unit 120, and a VSC dynamic adaptive reactive power support control unit 130. The term “unit” used in this application refers to a series of computer-readable instruction segments that can be accessed by a processor and can perform fixed functions, which are stored in storage devices.

The flexible DC same-frequency control unit is used to obtain a flexible DC power adjustment based on the sending-end grid frequency, the receiving-end grid frequency, and the system frequency reference value.

The conventional DC unilateral FLC control unit is used to output a conventional DC power adjustment based on the sending-end grid frequency and the system frequency reference value when the flexible DC power adjustment exceeds a preset limiting range and the system frequency deviation exceeds a preset frequency control dead-band.

The VSC dynamic adaptive reactive power support control unit is used to provide reactive power support based on the conventional DC power adjustment and the original reactive power reference value of the VSC.

The AC-DC hybrid synchronous grid system provided by this application adopts the dynamic coordination method of flexible DC same-frequency control and conventional DC unilateral FLC, as well as voltage support, in the aforementioned embodiment, which can solve the technical problem of insufficient frequency stability in asynchronous regional grids.

Compared with the existing technology, the beneficial effects of the AC-DC hybrid synchronous grid system provided by this application are as follows: the asynchronous DC sending and receiving end grids achieve real-time and automatic sharing of frequency regulation resources through the coordination of flexible DC same-frequency operation control and conventional DC unilateral FLC control, improving the frequency stability of the sending and receiving end grids. The VSC dynamic adaptive reactive power support control provides rapid reactive power support to the conventional DC in real-time and automatically, reducing the number of tap-changer and filter operations of the converter transformer during the adjustment of active power by the conventional DC unilateral FLC, and improving the reliability of DC power supply and equipment service life.

Other technical features of the AC-DC hybrid synchronous grid system are the same as those disclosed in the aforementioned embodiment methods, and will not be repeated here.

It should be noted that the specific implementation descriptions above are provided for the convenience of ordinary technicians in the field to understand and apply the invention, but the invention is not limited to the described implementations. The basic idea of this invention lies in providing a dynamic coordination method of flexible DC same-frequency control and conventional DC unilateral FLC, as well as voltage support, rather than the grid system in which the dynamic coordination method is applied. Any grid system that uses the dynamic coordination method and the invention provided by this invention falls within the scope of protection of this invention. Therefore, the invention is not limited to the aforementioned embodiments, and improvements and modifications made to the invention by technicians in the field based on the disclosure of this invention should all fall within the scope of protection of this invention.

The present application provides an AC-DC hybrid synchronous device, which includes: at least one processor; and a storage device communicatively connected to the at least one processor: wherein the storage device stores instructions executable by the at least one processor, and the instructions, when executed by the at least one processor, enable the at least one processor to perform the dynamic coordination method of flexible DC same-frequency control and conventional DC unilateral FLC, as well as voltage support, as described in the aforementioned embodiment.

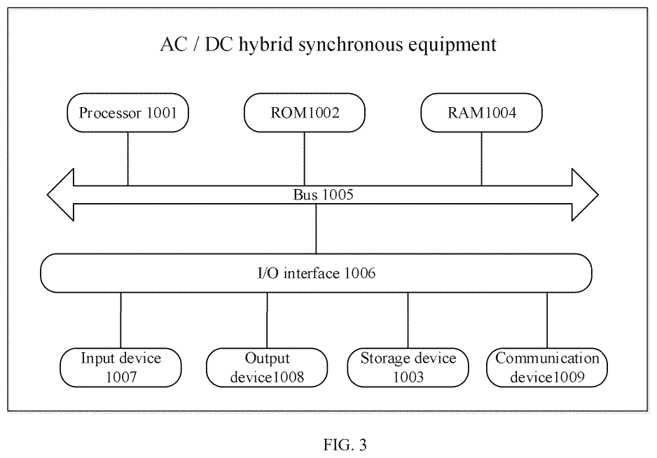

Now: referring to FIG. 3, it shows a structural diagram of an AC-DC hybrid synchronous device suitable for implementing the embodiment of the present application. The AC-DC hybrid synchronous device in the embodiment of the present application may include, but is not limited to, mobile terminals such as mobile phones, laptops. PDAs (Personal Digital Assistants). PADs (Portable Application Descriptions), and fixed terminals such as digital TVs and desktop computers. The AC-DC hybrid synchronous device shown in FIG. 3 is merely an example and should not limit the functionality and scope of use of the embodiment of the present application.

As shown in FIG. 3, the AC-DC hybrid synchronous device may include a processor 1001 (such as a central processing unit, graphics processing unit, etc.), which performs various appropriate actions and processes based on programs stored in a read-only memory (ROM) 1002 or programs loaded from a storage device 1003 into a random access memory (RAM) 1004. Various programs and data required for the operation of the AC-DC hybrid synchronous device are also stored in the RAM 1004. The processor 1001. ROM 1002, and RAM 1004 are connected to each other through a bus 1005. An input/output (I/O) interface 1006 is also connected to the bus. Typically, the following systems may be connected to the I/O interface 1006: input devices 1007, including touchscreens, touch panels, keyboards, mice, image sensors, microphones, accelerometers, gyroscopes, etc.: output devices 1008, such as liquid crystal displays (LCDs), speakers, vibrators, etc.: storage devices 1003, like magnetic tapes, hard drives, etc.; and communication devices 1009. The communication device 1009 may allow the AC-DC hybrid synchronous device to communicate wirelessly or wired with other devices to exchange data. Although the AC-DC hybrid synchronous device shown in the figure includes various systems, it should be understood that it is not necessary to implement or possess all of them. Alternatively, more or fewer systems may be implemented or possessed.

In particular, according to the embodiment disclosed in the present application, the process described above with reference to the flowchart can be implemented as a computer software program. For example, the embodiment disclosed in the present application includes a computer program product that includes a computer program carried on a computer-readable medium, the computer program containing program code for executing the method shown in the flowchart. In such an embodiment, the computer program may be downloaded and installed from the network via the communication device, or installed from the storage device 1003, or installed from the ROM 1002. When the computer program is executed by the processor 1001, it performs the functions defined in the method disclosed in the embodiment of the present application.

The AC-DC hybrid synchronous device provided by the present application adopts the dynamic coordination method of flexible DC same-frequency control and conventional DC unilateral FLC, as well as voltage support, as described in the aforementioned embodiment, which can solve the technical problem of insufficient frequency stability in asynchronous regional grids. Compared with the existing technology, the beneficial effects of the AC-DC hybrid synchronous device provided by the present application are the same as those of the dynamic coordination method of flexible DC same-frequency control and conventional DC unilateral FLC, as well as voltage support, provided by the aforementioned embodiment, and other technical features of the AC-DC hybrid synchronous device are the same as those disclosed in the previous embodiment method, and will not be repeated here.

It should be understood that the various parts disclosed in the present application may be implemented in hardware, software, firmware, or any combination of them. In the description of the aforementioned embodiments, specific features, structures, materials, or characteristics may be combined in any one or more embodiments or examples in a suitable manner.

The above description is only a specific embodiment of the present application, but the protection scope of the present application is not limited to this. Any skilled technician in the field of technology can easily think of variations or substitutions within the technical scope disclosed in the present application, which should be covered within the protection scope of the present application. Therefore, the protection scope of the present application should be based on the scope of protection of the claims described.

This application provides a computer-readable storage medium having computer-readable program instructions (i.e., computer programs) stored thereon. The computer-readable program instructions are used to execute the dynamically coordinated control method for flexible DC (FDC) same-frequency control, conventional DC (CDC) unilateral Fast Load Control (FLC), and voltage support as described in the aforementioned embodiments.

The computer-readable storage medium provided in this application can be, for example, a USB flash drive, but is not limited to systems, devices, or media of electricity, magnetism, optics, electromagnetism, infrared rays, or semiconductors, or any combination of the above. More specific examples of computer-readable storage media can include, but are not limited to: electrical connections with one or more wires, portable computer disks, hard disks. Random Access Memory (RAM). Read Only Memory (ROM). Erasable Programmable Read Only Memory (EPROM) or flash memory, optical fibers, portable Compact Disk Read Only Memory (CD-ROM), optical storage devices, magnetic storage devices, or any suitable combination of the above. In this embodiment, the computer-readable storage medium can be any tangible medium containing or storing a program that can be used by or in conjunction with an instruction execution system, system, or device. The program code contained on the computer-readable storage medium can be transmitted using any appropriate medium, including but not limited to: electrical wires, optical cables, Radio Frequency (RF), or any suitable combination of the above.

The aforementioned computer-readable storage medium can be included within AC-DC hybrid synchronous equipment: alternatively, it can exist independently without being assembled into AC-DC hybrid synchronous equipment.

The aforementioned computer-readable storage medium carries one or more programs. When the one or more programs are executed by AC-DC hybrid synchronous equipment, the equipment is caused to: obtain an FDC power adjustment amount based on the sending-end grid frequency, receiving-end grid frequency; and system frequency reference value: then, when the FDC power adjustment amount exceeds a preset amplitude limit range and the system frequency deviation exceeds a preset frequency control dead band, output a CDC power adjustment amount based on the sending-end grid frequency and the system frequency reference value; and further provide reactive power support based on the CDC power adjustment amount and the original reactive power reference value of the Voltage Source Converter (VSC).

The computer program code for executing the operations of this application can be written in one or more programming languages or combinations thereof. These programming languages include object-oriented programming languages such as Java, Smalltalk, C++, as well as conventional procedural programming languages such as the C language or similar programming languages. The program code can be executed entirely on the user's computer, partially on the user's computer, as an independent software package, partially on the user's computer and partially on a remote computer, or entirely on a remote computer or server. In cases involving remote computers, the remote computer can be connected to the user's computer through any type of network, including a Local Area Network (LAN) or a Wide Area Network (WAN), or can be connected to an external computer, for example, using an Internet service provider to connect through the Internet.

The flowcharts and block diagrams in the accompanying drawings illustrate the possible architecture, functionality, and operation of the systems, methods, and computer program products according to various embodiments of this application. In this regard, each block in the flowchart or block diagram can represent a module, program segment, or portion of code that contains one or more executable instructions for implementing the specified logical function. It should also be noted that in some alternative implementations, the functions noted in the blocks can occur in a different order than that shown in the drawings. For example, two blocks shown in succession can actually be executed substantially in parallel, and they can sometimes be executed in the reverse order, depending on the involved functionality. It is also important to note that each block in the block diagrams and/or flowcharts, as well as combinations of blocks in the block diagrams and/or flowcharts, can be implemented using a dedicated hardware-based system for performing the specified function or operations, or can be implemented using a combination of dedicated hardware and computer instructions.

The modules referred to in the embodiments of this application can be implemented through software or hardware. The names of the modules do not, in some cases, constitute a limitation on the unit itself.

The readable storage medium provided in this application is a computer-readable storage medium that stores computer-readable program instructions (i.e., computer programs) for executing the dynamically coordinated control method for FDC same-frequency control, CDC unilateral FLC, and voltage support. It solves the technical problem of insufficient frequency stability in asynchronous regional power grids. Compared with the prior art, the beneficial effects of the computer-readable storage medium provided in this application are the same as those of the dynamically coordinated control method for FDC same-frequency control, CDC unilateral FLC, and voltage support provided in the aforementioned embodiments, and will not be repeated here.

The above description is only a partial embodiment of this application and does not limit the patent scope of this application. Any equivalent structural transformation made under the technical concept of this application, or direct/indirect application in other related technical fields, is included within the patent protection scope of this application.

1. A dynamic coordination method for flexible direct current (FDC) synchronous frequency control in conjunction with conventional DC (CDC) unilateral Fast Load Control (FLC) and voltage support, comprising:
obtaining FDC power adjustment based on a sending-end grid frequency; a receiving-end grid frequency, and a system frequency reference value;
when the FDC power adjustment exceeds a preset limiting range and a system frequency deviation exceeds a preset frequency control dead band, outputting a CDC power adjustment based on the sending-end grid frequency and the system frequency reference value; and
providing a reactive power support based on the CDC power adjustment and an original reactive power reference value of a Voltage Source Converter (VSC);
wherein after the step of outputting the CDC power adjustment based on the sending-end grid frequency and the system frequency reference value when the FDC power adjustment exceeds the preset limiting range and the system frequency deviation exceeds the preset frequency control dead band, the dynamic coordination method further comprises:
performing logical judgment, per-unit conversion, and Proportional-Integral (PI) control on the CDC power adjustment to obtain a firing angle adjustment corresponding to the CDC power adjustment; and
adjusting an actual operating power of the CDC based on the firing angle adjustment and a range of the CDC power adjustment.

2. The dynamic coordination method according to claim 1, wherein the step of obtaining the FDC power adjustment based on the sending-end grid frequency, the receiving-end grid frequency; and the system frequency reference value comprises:
determining a difference between the sending-end grid frequency and the system frequency reference value, and determining a difference between the receiving-end grid frequency and the system frequency reference value; and
performing filtering, DC blocking, PI control, and limiting operations on the difference between the sending-end grid frequency and the system frequency reference value and the difference between the receiving-end grid frequency and the system frequency reference value, respectively, to obtain the FDC power adjustment.

3. The dynamic coordination method according to claim 1, wherein after the step of obtaining the FDC power adjustment based on the sending-end grid frequency, the receiving-end grid frequency, and the system frequency reference value, the dynamic coordination method further comprises:
adding the FDC power adjustment to an original power reference value of the flexible DC to obtain a VSC active power command; and
adjusting an actual operating power of the flexible DC based on the VSC active power command and a range of the FDC power adjustment.

4. The dynamic coordination method according to claim 3, wherein before the step of adjusting the actual operating power of the flexible DC based on the VSC active power command and the range of the FDC power adjustment, the dynamic coordination method further comprises:
determining an upper limit of the range of the FDC power adjustment based on a rated power of the flexible DC, the actual operating power of the flexible DC, and a flexible DC overload capability factor;
determining a lower limit of the range of the FDC power adjustment based on the rated power of the flexible DC, the actual operating power of the flexible DC, and a minimum operating level factor of the flexible DC power; and
determining the range of the FDC power adjustment based on the upper limit and the lower limit of the range of the FDC power adjustment.

5. The dynamic coordination method according to claim 1, wherein the step of providing the reactive power support based on the CDC power adjustment and the original reactive power reference value of the VSC comprises:
performing a power factor calculation on the CDC power adjustment to obtain an additional reactive power adjustment for the VSC;
adding the additional reactive power adjustment for the VSC to an original reactive power command of the VSC to obtain an updated reactive power command for the VSC; and
providing the reactive power support based on the updated reactive power command for the VSC, wherein the reactive power support comprises adjusting a reactive power output by the flexible DC.

6. The dynamic coordination method according to claim 5, wherein the step of performing the power factor calculation on the CDC power adjustment to obtain the additional reactive power adjustment for the VSC comprises:
determining a tangent value of a power factor measured at valves of a conventional DC connected to the flexible DC; and
performing a multiplication operation on the tangent value and the CDC power adjustment to obtain the additional reactive power adjustment for the VSC.

7. A system for implementing the dynamic coordination method according to claim 1, comprising:
an FDC same-frequency control unit for obtaining the FDC power adjustment based on the sending-end grid frequency, the receiving-end grid frequency, and the system frequency reference value;
a CDC unilateral FLC control unit for outputting the CDC power adjustment based on the sending-end grid frequency and the system frequency reference value when the FDC power adjustment exceeds the preset limiting range and the system frequency deviation exceeds the preset frequency control dead band; and
a VSC dynamic adaptive reactive power support control unit for providing the reactive power support based on the CDC power adjustment and the original reactive power reference value of the VSC.

8. An alternating current (AC)-DC hybrid synchronous equipment, comprising:
a storage device storing computer-readable instructions; and
a processor executing the computer-readable instructions stored in the storage device to implement the dynamic coordination method according to claim 1.

9. A storage medium, wherein the storage medium stores computer-readable instructions, and the computer-readable instructions are configured to, when executed by a processor in AC-DC hybrid synchronous equipment, implement the dynamic coordination method according to claim 1.

10. The AC-DC hybrid synchronous equipment according to claim 8, wherein in the dynamic coordination method, the step of obtaining the FDC power adjustment based on the sending-end grid frequency, the receiving-end grid frequency, and the system frequency reference value comprises:
determining a difference between the sending-end grid frequency and the system frequency reference value, and determining a difference between the receiving-end grid frequency and the system frequency reference value; and
performing filtering, DC blocking, PI control, and limiting operations on the difference between the sending-end grid frequency and the system frequency reference value and the difference between the receiving-end grid frequency and the system frequency reference value, respectively, to obtain the FDC power adjustment.

11. The AC-DC hybrid synchronous equipment according to claim 8, wherein after the step of obtaining the FDC power adjustment based on the sending-end grid frequency, the receiving-end grid frequency, and the system frequency reference value, the dynamic coordination method further comprises:
adding the FDC power adjustment to an original power reference value of the flexible DC to obtain a VSC active power command; and
adjusting an actual operating power of the flexible DC based on the VSC active power command and a range of the FDC power adjustment.

12. The AC-DC hybrid synchronous equipment according to claim 11, wherein before the step of adjusting the actual operating power of the flexible DC based on the VSC active power command and the range of the FDC power adjustment, the dynamic coordination method further comprises:
determining an upper limit of the range of the FDC power adjustment based on a rated power of the flexible DC, the actual operating power of the flexible DC, and a flexible DC overload capability factor;
determining a lower limit of the range of the FDC power adjustment based on the rated power of the flexible DC, the actual operating power of the flexible DC, and a minimum operating level factor of the flexible DC power; and
determining the range of the FDC power adjustment based on the upper limit and the lower limit of the range of the FDC power adjustment.

13. The AC-DC hybrid synchronous equipment according to claim 8, wherein in the dynamic coordination method, the step of providing the reactive power support based on the CDC power adjustment and the original reactive power reference value of the VSC comprises:
performing a power factor calculation on the CDC power adjustment to obtain an additional reactive power adjustment for the VSC;
adding the additional reactive power adjustment for the VSC to an original reactive power command of the VSC to obtain an updated reactive power command for the VSC; and
providing the reactive power support based on the updated reactive power command for the VSC, wherein the reactive power support comprises adjusting a reactive power output by the flexible DC.

14. The AC-DC hybrid synchronous equipment according to claim 13, wherein in the dynamic coordination method, the step of performing the power factor calculation on the CDC power adjustment to obtain the additional reactive power adjustment for the VSC comprises:
determining a tangent value of a power factor measured at valves of a conventional DC connected to the flexible DC; and
performing a multiplication operation on the tangent value and the CDC power adjustment to obtain the additional reactive power adjustment for the VSC.

15. The storage medium according to claim 9, wherein in the dynamic coordination method, the step of obtaining the FDC power adjustment based on the sending-end grid frequency, the receiving-end grid frequency, and the system frequency reference value comprises:
determining a difference between the sending-end grid frequency and the system frequency reference value, and determining a difference between the receiving-end grid frequency and the system frequency reference value; and
performing filtering, DC blocking, PI control, and limiting operations on the difference between the sending-end grid frequency and the system frequency reference value and the difference between the receiving-end grid frequency and the system frequency reference value, respectively, to obtain the FDC power adjustment.

16. The storage medium according to claim 9, wherein after the step of obtaining the FDC power adjustment based on the sending-end grid frequency, the receiving-end grid frequency, and the system frequency reference value, the dynamic coordination method further comprises:
adding the FDC power adjustment to an original power reference value of the flexible DC to obtain a VSC active power command; and
adjusting an actual operating power of the flexible DC based on the VSC active power command and a range of the FDC power adjustment.

17. The storage medium according to claim 16, wherein before the step of adjusting the actual operating power of the flexible DC based on the VSC active power command and the range of the FDC power adjustment, the dynamic coordination method further comprises:
determining an upper limit of the range of the FDC power adjustment based on a rated power of the flexible DC, the actual operating power of the flexible DC, and a flexible DC overload capability factor;
determining a lower limit of the range of the FDC power adjustment based on the rated power of the flexible DC, the actual operating power of the flexible DC, and a minimum operating level factor of the flexible DC power; and
determining the range of the FDC power adjustment based on the upper limit and the lower limit of the range of the FDC power adjustment.

18. The storage medium according to claim 9, wherein in the dynamic coordination method, the step of providing the reactive power support based on the CDC power adjustment and the original reactive power reference value of the VSC comprises:
performing a power factor calculation on the CDC power adjustment to obtain an additional reactive power adjustment for the VSC;
adding the additional reactive power adjustment for the VSC to an original reactive power command of the VSC to obtain an updated reactive power command for the VSC; and
providing the reactive power support based on the updated reactive power command for the VSC, wherein the reactive power support comprises adjusting a reactive power output by the flexible DC.

19. The storage medium according to claim 18, wherein in the dynamic coordination method, the step of performing the power factor calculation on the CDC power adjustment to obtain the additional reactive power adjustment for the VSC comprises:
determining a tangent value of a power factor measured at valves of a conventional DC connected to the flexible DC; and
performing a multiplication operation on the tangent value and the CDC power adjustment to obtain the additional reactive power adjustment for the VSC.
